(19) United States
(12) Patent Application Publication
(10) Pub. No.: US 2014/0062197 A1
(43) Pub. Date: Mar. 6, 2014

(54) Method for Managing Reserved Electrical Power and System Thereof

(71) Applicant: HONG WEI LIN, Nantou County (TW)

(72) Inventor: HONG WEI LIN, Nantou County (TW)

(21) Appl. No.: 13/896,733

(22) Filed: May 17, 2013

(30) Foreign Application Priority Data
Sep. 5, 2012 (TW) 101132370

(51) Int. Cl. H02J 4/00

(52) U.S. Cl. CPC H02J 4/00
USPC 307/39

(57) ABSTRACT

Disclosed is a method for managing reserved electrical power and system thereof, the method includes the steps of: (a) acquiring a peak load value of the power generating device of the current time period; (b) computing a reserved electrical power value of the current time period based on a gross generation value of the power generating device of the current time period and the peak load value of the current time period; (c) comparing the reserved electrical power value of the current time period with a preset reserved electrical power value of the current time period; (d) capturing an available power from the power generating device based on the reserved electrical power of the current time period when the reserved electrical power value is larger than the preset reserved electrical power value; and (e) delivering the available power to an electrolyzing device to generate oxygen and hydrogen from water.

### FIELD OF THE INVENTION

The present invention relates to a method and a system for managing electrical power, and more particularly to a method for managing reserved electrical power and a system thereof.

### BACKGROUND OF THE INVENTION

The supply of electricity has been greatly developed and is indispensable nowadays since the light bulb was invented in 1879. In this way, the reliable supply of electric power has been paid a great attention by all fields including academic unit, electricity industry, government and even by most consumers.

To prevent the power generating device from dropping offline or shunting down, the demand of total expected demanding electrical power is estimated before the electrical power really generated, and the electrical power really generated should be greater than the total expected demanding electrical power to achieve the object of reliability for electrical power generation. It is noted that the difference between the electrical power really generated and the total expected demanding electrical power is referred to as the reserved electrical power.

For generating electrical power greater than the total expected demanding electrical power, it requires to the warm-up of the non-spinning machine, or alternatively to add the warmed up machine to the networks of operating system. However, when the real demanding electrical power is smaller than the total expected demanding electrical power, it still causes the excess electrical power be useless and be wasted.

### SUMMARY OF THE INVENTION

In view of the reasons above, a higher reserved electrical power is provided, a better reliability of electricity power generation is ensured. But, if the excess electrical power, which is not able to be stored, is not used, it will be wasted and causes the environment pollutions.

Accordingly, the present invention provides a method and system for managing reserved electrical power to effectively use the reserved electrical power to reduce the waste of the resource.

In one of the aspect, the present invention overcomes the drawbacks of the prior art by providing a method for managing reserved electrical power, comprising steps of : (a) acquiring a peak load value of the power generating device of the current time period; (b) computing a reserved electrical power value of the current time period based on a gross generation value of the power generating device of the current time period and the peak load value of the power generating device of the current time period; (c) comparing the reserved electrical power value of the current time period with a preset reserved electrical power value of the current time period;(d) capturing an available power from the power generating device based on the reserved electrical power of the current time period when the reserved electrical power value of the current time period is larger than the preset reserved electrical power value of the current time period; and (e) delivering the available power to an electrolyzing device to generate oxygen and hydrogen from water.

In another aspect of the present invention, it further comprises, in the step (d), of adjusting the amount of the available power according to a electricity price of current time period.

In another aspect of the present invention, it further comprises, between step (d) and step (e), of rectifying the available power from AC to DC, if the available power is AC.

In another aspect of the present invention, it further comprises a step, after step (c), of disconnecting the power generating device from the electrolyzing device when the reserve electrical power value is smaller than or equal to the preset reserved electrical power value.

In another aspect of the present invention, it further comprises a step, after step (e), of storing the oxygen and hydrogen generated by the electrolyzing device.

In one of the aspect, the present invention overcomes the drawbacks of the prior art by providing a system of managing reserved electrical power of a power generating device, the system being connected between the power generating device and an electrolyzing device, the system comprising: a data acquiring device, provided to acquire a peak load value of the power generating device of the current time period, a computing device, which is connected to the data acquiring device, computing a reserved electrical power value of the current time period based on a gross generation value of the power generating device of the current time period and the peak load value of the power generating device of the current time period, a comparing device, which is connected to the computing device, comparing the reserved electrical power value of the current time period with a preset reserved electrical power value of the current time period, a capturing device, which is connected to the comparing device, capturing an available power from the power generating device based on the reserved electrical power value of the current time period when the reserved electrical power value is larger than the preset reserved electrical power value, and a delivering device, which is connected between the capturing device and the electrolyzing device, delivering the available power to the electrolyzing device to generate oxygen and hydrogen from water.

In another aspect of the present invention, it further comprises an adjusting device, connected with the capturing device, for adjusting the amount of the available power according to a electricity price of the current time period.

In another aspect of the present invention, it further comprises a rectifying device, connected between the capturing device and the delivering device, for converting the available power from AC to DC

In another aspect of the present invention, it further comprises a switch device, connected between the delivering device and the electrolyzing device, for switching as being connected or disconnected between the delivering device and the electrolyzing device.

In another aspect of the present invention, it further comprises an oxygen storage device and a hydrogen storage device which are connected with the electrolyzing device, for storing the oxygen and hydrogen generated by the electrolyzing device.

By means of the present invention, it acquires the excess portion of the reserved electrical power to supply to the electrolyzing device. Accordingly, the excess portion of the reserved electrical power which is generally not used is utilized to generate oxygen and hydrogen, so that it enhances a further economic benefits and reduces the waste of resource.

Moreover, the generated oxygen and hydrogen, which are electrolyzed from water, is stored to not only manufacture fuel cells, but also be able to supply to the gas station by selling them. Further, on the electricity peak, the stored hydrogen can be burned to drive the turbofan engine to generate power to thus achieve the reuse of electricity. In addition, it allows the present invention to adjust the amount of reserved electrical power to be acquired in accordance with the selling price of the electrical power during a specific time period that it is acquired. Thereafter, the electrolyzing device is operated by using the reserved electrical power in a manner of more effectiveness.

### BRIEF DESCRIPTION OF THE DRAWINGS

The structure and the technical means adopted by the present invention to achieve the above and other objects can be best understood by referring to the following detailed description of the preferred embodiments and the accompanying drawings.

FIG. 1 is a schematic diagram illustrating the system for managing reserved electrical power of power generating device of the embodiment according to the present invention;

FIG. 2 is a block diagram illustrating the system for managing reserved electrical power of power generating device of the embodiment according to the present invention;

FIG. 3 is a flowchart illustrating the method for managing reserved electrical power of power generating device of the embodiment according to the present invention.

### DETAILED DESCRIPTION OF THE PREFERRED EMBODIMENTS

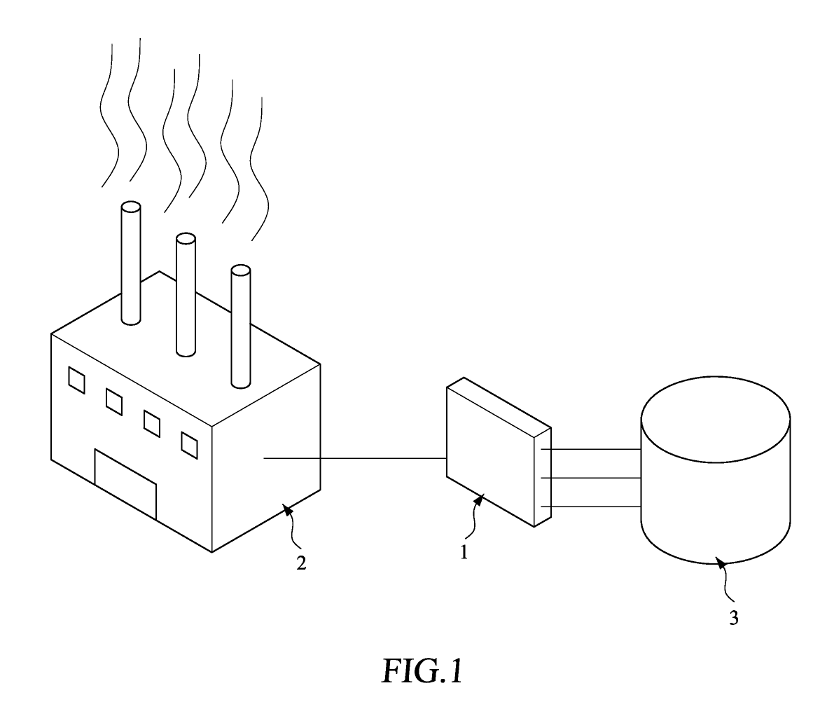

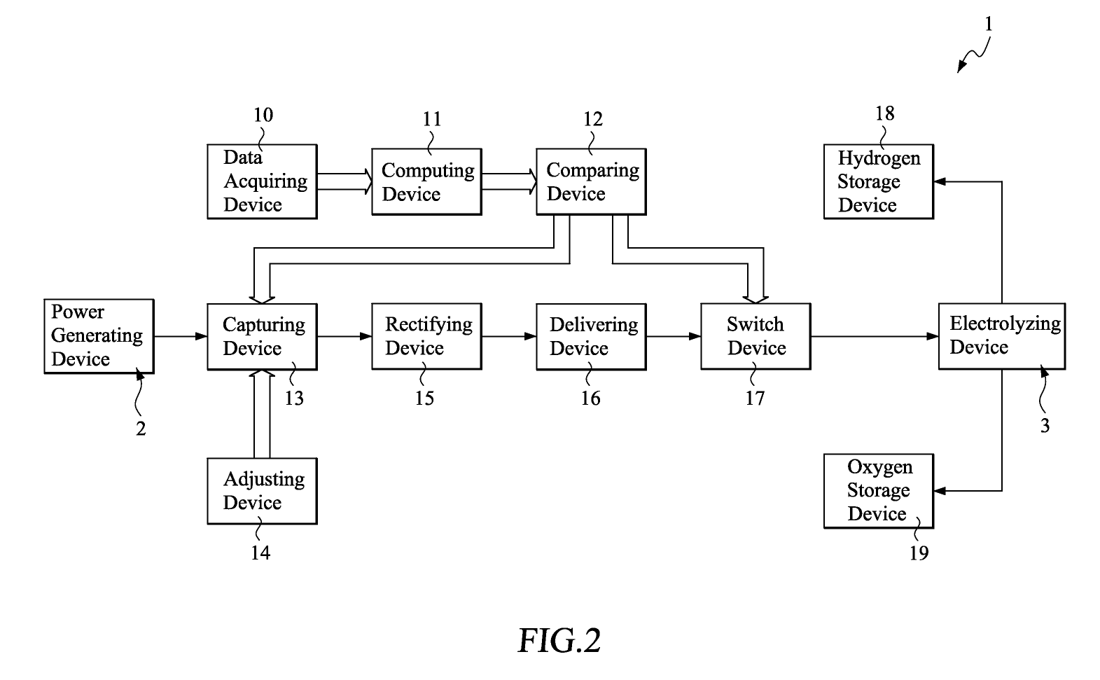

Please refer to FIGS. 1 and 2, FIG. 2 is a block diagram of a system for managing reserved electrical power of power generating device, FIG. 2 is a block diagram of a system for managing reserved electrical power of power generating device.

As shown in FIG. 1 and FIG. 2, a system for managing reserved electrical power 1, which is connected between a power generating device 2 and a electrolyzing device 3, includes a data acquiring device 10, a computing device 11, a comparing device 12, a capturing device 13, an adjusting device 14, a rectifying device 15, a delivering device 16, a switch device 17, an oxygen storage device 18 and a hydrogen storage device 19. In this embodiment, the computing device 11 is connected with the data acquiring device 10, the comparing device 12 is connected with the computing device 11, the capturing device 13 is connected with the comparing device 12 and the power generating device 2, a delivering device 16 is connected between the capturing device 13 and the electrolyzing device 3, the rectifying device 15 is connected between the capturing device 13 and the delivering device 16, the switch device 17 is connected between delivering device 16 and the electrolyzing device 3, the oxygen storage device 18 and the hydrogen storage device 19 are connected with the electrolyzing device 3. In this embodiment, the power generating device 2 is a power plant.

Generally, the data acquiring device 10 is used for acquiring a peak load value E1 of the power generating device 2 of the current time period, wherein the peak load value E1 of the current time period is the highest output power value of power generating device 2 at a specific time, and it can be estimated based on the variables such as the factors of economic, weather, population growth, etc. For example, the current peak load value E1 of the current time period can be determined by the data acquiring device 10 according to a historical database (not shown) that reveals a peak load value at the same specific time period in the past. Furthermore, the peak load value E1 of the current time period can also be determined by operators, who can manually input the value E1 to the data acquiring device 10, according to the current network loading of power generating device 2.

Computing device 11, connected with the data acquiring device 10, is used for receiving the current peak load value E1 from the data acquiring device 10, and for computing it with a gross generation value E2 of the power generating device 2 of the current time period to obtain a reserved electrical power value E3 of the current time period. Generally, the difference between the gross generation value E2 of the current time period and the peak load value E1 of the current time period is the reserved electrical power value E3 of the current time period. However, the reserved electrical power value E3 of the current time period may also be obtained from a look-up table according to the peak load value E1 of the current time period by a computing device 11.

The comparing device 12, connected with the computing device 11, is used for comparing the reserved electrical power value E3 of the current time period with a preset reserved electrical power value E4 of the current time period. After the comparison, the comparing device 12 will generate a control signal to control the capturing device 13 and the switch device 17 based on the result of comparison. In this embodiment, the preset reserved electrical power value E4 of the current time period is used for evaluating whether the reserved electrical power value E3 of the current time period is large enough for further usage or not. If the preset reserved electrical power value E4 of the current time period is smaller than the reserved electrical power value E3 of the current time period, it indicates the electrical power in demand according to the past experience is weak, so the current reserved electrical power is allowable for other usage The preset reserved electrical power value E4 of the current time period can be determined according to the historical data of electricity consumption, the capacity of power generation of the power generating device 2, and the demand of electrolyzing device 3, etc.

The capturing device 13 is connected with power generating device 2. Generally, the capturing device 13 can be a device such as an electricity distribution board. As mentioned, if the reserved electrical power value E3 is large than the preset reserved electrical power value E4 as compared by the comparing device 12, the capturing device 13 will be allowed to capture an available power V1 from the power generating device 2, and then the available power V1 will be delivered to the electrolyzing device 3 via the delivering device 16.

Moreover, the result of comparison of the comparing device 12, the amount of the available power V1 captured by the capturing device 13, can be adjusted by information such as the electricity price of the current time period. In this embodiment, the capturing device 13 is connected with an adjusting device 14 used for adjusting the amount of the available power V1. Substantially, the adjusting device 14 includes a receiving unit and a processing unit, the receiving unit receives the electricity price of the current time period to the processing unit, the processing unit generates different control signal to the capturing device 13 according to the different electricity price to switch different loadings applied in the capturing device 13. In this way, if the electricity price in the current time period is much cheaper than that in the normal time period (i.e. night off-peak period), the adjusting device 14 will capturing more available power V1, otherwise, the adjusting device will capturing s available power V1.

The rectifying device 15 is connected between the capturing device 13 and the delivering device 16. In this embodiment, the rectifying device 15 is a rectifier. If the available power V1 is AC, it will be rectified to DC and be transferred to the delivering device 16. Otherwise, if the available power V1 is DC, the available power V1 will be transferred directly to the delivering device 16 without being rectified.

In this embodiment, the delivering device 16 is a transformer, which is used for adjusting the voltage of the available power V1 and for delivering the available power V1 to electrolyzing device 3. The switching device 17, connected between the delivering device 16 and the electrolyzing device 3, is used for switching as being connected or disconnected between the delivering device 16 and the electrolyzing device 3 according to the result of comparison of the comparing device 12. Specifically, if the reserved electrical power value E3 is smaller than or equal to the preset reserved electrical power value E4, then the switching device 17 will be switched to open circuit, so that the electrical connection between delivering device 16 and electrolyzing device 3 will be switching as being disconnected. Otherwise, if the reserved electrical power value E3 is large than the preset reserved electrical power value E4, switched device 17 will be switched to close circuit, and the electrical connection between delivering device 16 and electrolyzing device 3 will be switched conducted . As a result, the available power V1 will not be captured if the reserved electrical power is insufficient.

The oxygen storage device 18 and the hydrogen storage device 19 are connected with the electrolyzing device 3. The electrolyzing device 3 receives the available power V1 for electrolyzing water to generate oxygen and hydrogen. After electrolyzing water, the oxygen and hydrogen generated by electrolyzing device 3 will be stored in the oxygen storage device 18 and the hydrogen storage device 19 respectively.

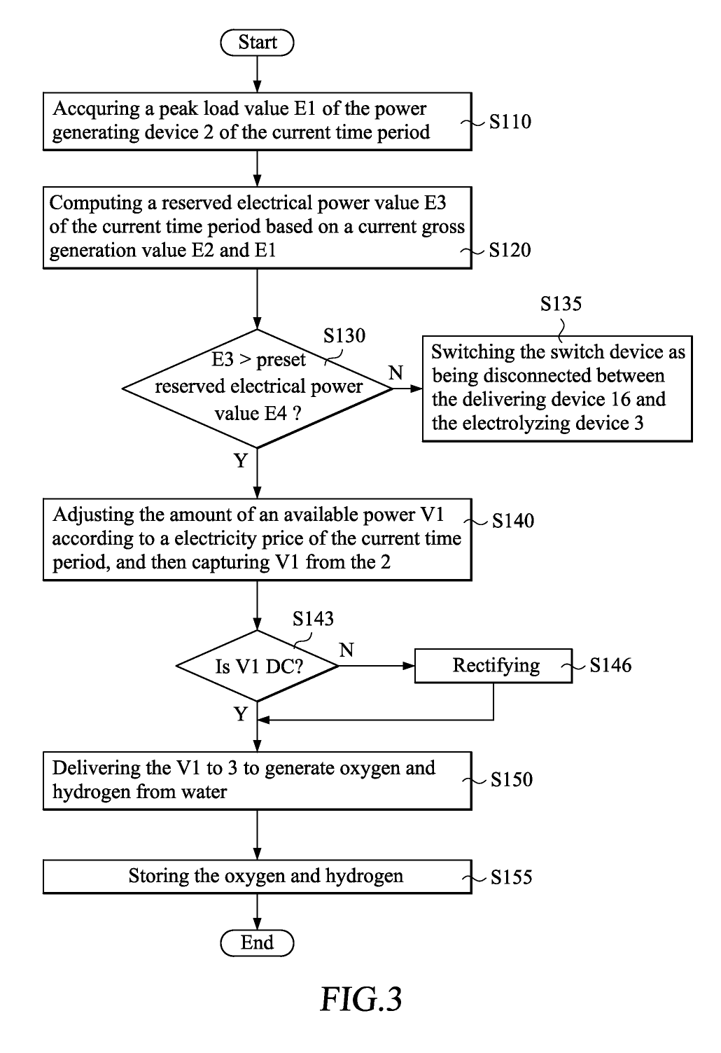

Please refer to the FIG. 3. FIG. 3 is a flowchart of a method for managing reserved electrical power of the power generating device. The method for managing the reserve electrical power of the power generating device includes the steps as follows. Firstly, a peak load value E1 of the power generating device 2 of the current time period is acquired (step S110). The manners about how to acquire the current peak load value E1 has been described above, which will not repeated for simplicity.

Next, a reserved electrical power value E3 of the current time period is computed based on a current gross generation value E2 of the power generating device 2 of the current time period and the peak load value E1 of the power generating device 2 of the current time period (step S120). In this embodiment, the gross generation value E2, also referred to as a net value of electrical power generation, is obtained by subtracting the amount consuming in the power station from the amount of total electricity generation. If the generated electricity becomes decreased for the reason that the station is broken down or is under maintenance, it becomes that the reserved electrical power value E3 will be also decreased. The reserved electrical power value E3 is one of the reliability indices of power generating device 2 in electricity generation. It means that if the larger reserved electrical power value E3 is, the greater reliability of power generating device 2 in electricity generation becomes.

After the reserved electrical power E3 of the current time period is computed, the reserved electrical power value E3 of the current time period is compared with a preset reserved electrical power value E4 of the current time period (step 130). In this embodiment, by multiplying E3 in historical database with a value between zero and one, the preset reserved electrical power value E4 can be obtained. By the way that the reserved electrical power value E3 with preset reserved electrical power value E4 is computed, it ensures that the reserved electrical power is captured only when the reserved electrical power is sufficient.

When the reserved electrical power value E3 is smaller than or equal to the preset reserved electrical power value E4, the electricity connection between the power generating device 2 and the electrolyzing device 3 will be disconnected (step 135). This step is used for preventing the capture of reserved electrical power, which may affect a normal electrical power supply, when the reserve electrical power is insufficient.

When the reserved electrical power value E3 of the current time period is large than the preset reserved electrical power value E4 of the current time period, the available power V1 is captured from the power generating device (step 140). The capturing amount of the available power V1 can be adjusted according to the electricity price of the current time period to thus increase the efficiency in capturing the available power V1.

The power generating device 2 may be different with the type of AC or DC electricity power. To ensure that a DC power be delivered to the electrolyzing device 3, the available power V1 should be checked as AC or DC before being captured (step 143). Then, if the available V1 power is AC, the available power V1 will be rectified to DC by the rectifying device 15 (step 146).

If the available power V1 is DC, then the available power V1 will be delivered directly to the electrolyzing device 3, for generating oxygen and hydrogen (step 150). Preferably, before delivering the available power V1 to the electrolyzing device 3, the voltage of available power V1 can be adjusted to the voltage suitable for the electrolyzing device 3.

Finally, for effectively using the generated products electrolyzed from water, the generated product of oxygen and hydrogen, which are generated by electrolyzing water, are stored after electrolyzing (step 155). In the manner of storing the oxygen and the hydrogen, the stored oxygen and the hydrogen can not only be used to manufacture fuel cells, but also can be provided for the gas stating by selling them. Further, on the electricity peak, the stored hydrogen can be burned to drive the turbofan engine to generate power, which achieves the reuse of electricity.

With the method above, the reserved electrical power generated by the power generating device is captured to supply to the electrolyzing device 3. As the result, the power which is generally not used is utilized to generate oxygen and hydrogen to thus it enhances a further economic benefits and reduce the waste of resource. Moreover, the system for managing reserved electrical power 1 is provided with the oxygen storage device 18 and the hydrogen storage device 19 for storing oxygen and hydrogen that is generated by electrolyzing water, so the stored oxygen and hydrogen can be reused not only for manufacturing fuel cells, but also can be supplied to the gas station by selling them. Further, on the electricity peak, the stored hydrogen can be burned to drive the turbofan engine to generate electricity power to thus achieve the reuse of electricity. In addition, the captured value of the available power V1 is adjusted according to a current electricity price, so that the electrolyzing device can use the reserved electrical power in a manner of effectiveness.

As can be appreciated from the above embodiments, the method and system for managing reserved electrical power of power generating device of the present invention has merits which meet the requirement for a patent. The above description should be considered as only the discussion of the preferred embodiments of the present invention. However, a person skilled in the art may make various modifications to the present invention. Those modifications still fall within the spirit and scope defined by the appended claims.

What is claimed is:

1. A method for managing reserved electrical power of a power generating device, comprising the steps of:
(a) acquiring a peak load value of the power generating device of the current time period;
(b) computing a reserved electrical power value of the current time period based on a gross generation value of the power generating device of the current time period and the peak load value of the power generating device of the current time period;
(c) comparing the reserved electrical power value of the current time period with a preset reserved electrical power value of the current time period;
(d) capturing an available power from the power generating device based on the reserved electrical power of the current time period when the reserved electrical power value of the current time period is larger than the preset reserved electrical power value of the current time period; and
(e) delivering the available power to an electrolyzing device to generate oxygen and hydrogen from water.

2. The method as claimed in claim 1, further comprising a step, in the step (d), of adjusting the amount of the available power according to a electricity price of current time period.

3. The method as claimed in claim 1, further comprising a step, between step (d) and step (e), of rectifying the available power from AC to DC, if the available power is AC.

4. The method as claimed in claim 1, further comprising a step, after step (c), of disconnecting the power generating device from the electrolyzing device when the reserved electrical power value is smaller than or equal to the preset reserved electrical power value.

5. The method as claimed in claim 1, further comprising a step, after step (e), of storing the oxygen and hydrogen generated by the electrolyzing device.

6. A system of managing reserved electrical power of a power generating device, the system being connected between the power generating device and an electrolyzing device, the system comprising:
a data acquiring device, provided to acquire a peak load value of the power generating device of the current time period;
a computing device, which is connected to the data acquiring device, computing a reserved electrical power value of the current time period based on a gross generation value of the power generating device of the current time period and the peak load value of the power generating device of the current time period;
a comparing device, which is connected to the computing device, comparing the reserved electrical power value of the current time period with a preset reserved electrical power value of the current time period;
a capturing device, which is connected to the comparing device, capturing an available power from the power generating device based on the reserved electrical power value of the current time period when the reserved electrical power value is larger than the preset reserved electrical power value; and
a delivering device, which is connected between the capturing device and the electrolyzing device, delivering the available power to the electrolyzing device to generate oxygen and hydrogen from water.

7. The system as claimed in claim 6, further comprising an adjusting device, connected with the capturing device, for adjusting the amount of the available power according to a electricity price of the current time period.

8. The system as claimed in claim 6, further comprising a rectifying device, connected between the capturing device and the delivering device, for converting the available power from AC to DC if the available power is AC.

9. The system as claimed in claim 6, further comprising a switch device, connected between the delivering device and the electrolyzing device, for switching the connection between the delivering device and the electrolyzing device as being connected or disconnected.

10. The system as claimed in claim 6, further comprising an oxygen storage device and a hydrogen storage device which are connected with the electrolyzing device, for storing the oxygen and hydrogen generated by the electrolyzing device.
